(19) United States
(12) Patent Application Publication
(10) Pub. No.: US 2026/0220617 A1
(43) Pub. Date: Jul. 30, 2026

(54) DATA COMMUNICATIONS NETWORK AND METHOD FOR ASSISTING USERS WITH APPARATUS SERVICE/MAINTENANCE

(71) Applicant: Bryce Francis DURRANT, Woodlands (AU)

(72) Inventor: Bryce Francis DURRANT, Woodlands (AU)

(21) Appl. No.: 19/159,054

(22) PCT Filed: Feb. 23, 2024
(86) PCT No.: PCT/AU2024/050144

§ 371 Date: Aug. 22, 2025

(30) Foreign Application Priority Data
Feb. 23, 2023 (AU) 2023900469

(51) Int. Cl. G06Q 10/20

(52) U.S. Cl. CPC G06Q 10/20

(57) ABSTRACT

A data communications network including connected data communications devices to assist a user to service or maintain an apparatus. The method includes receiving identification details regarding the apparatus, performing, using artificial intelligence techniques, a search of available resources to identify items matching the apparatus, providing a listing of all available matching items, receiving a selection for which the user seeks servicing or maintenance assistance, retrieving a copy of service or maintenance documents relating to the apparatus selected and identifying, using natural language processing techniques, guidance within the document(s) regarding servicing or maintenance of the apparatus, initiating queries to the user regarding the previous use, service and/or maintenance of the apparatus to determine a current servicing or maintenance status of the apparatus, based upon the response(s) received and said guidance regarding service or maintenance of the apparatus, establishing a servicing or maintenance schedule or a modification to an existing servicing or maintenance schedule, and providing one or more service or maintenance notifications to the data communications device of the user.

### FIELD OF THE INVENTION

The present invention relates to a data communications network and a method of operating same for assisting assisting users to maintain various type of apparatus including equipment and machinery.

### BACKGROUND OF THE INVENTION

Proper care and routine maintenance is required for machinery and equipment including, for example, engines, automobiles, generators, medical equipment, etc, with such care and maintenance recommended to ensure the machinery and equipment is maintained in good working condition, and preferably optimal condition, thereby improving the operational life of the apparatus and saving the owner expense, time and effort with respect to significant repairs to correct fault conditions or the requirement to replace the apparatus in the event of otherwise avoidable failure.

However, maintaining equipment and machinery requires owners to invest time and cost. Whilst it is important for owners to avoid under-servicing their equipment, over-servicing of equipment should also be avoided. Preferably, owners should aim to ensure efficient performance of their machinery and equipment by attending to timely maintenance, yet at the same time, avoid wastage of time, effort and cost associated with over-maintaining machinery and equipment.

Existing systems and methods for assisting owners to understand the servicing requirements including the requirement to remember due dates for servicing machinery and equipment are unreliable. For example, although owners of vehicles are notified of the next service date based upon a servicing of their motor vehicle, usually by a stamp in their service manual or the use of a sticker affixed to an internal surface of their vehicle, such methods rely upon the owner proactively checking their service manual or the affixed notice in the vehicle. Furthermore, owners of machinery and equipment tend to lose physical/hard-copy receipts, manuals and documents associated with servicing and maintaining their equipment and machinery, and hence it is often difficult for owners to understand and track required servicing requirements.

To avoid the requirement to proactively check servicing requirements of their machinery and equipment, some owners enter dates in calendars associated with their smart electronic devices. However, such methods do not take into account factors such as amount of use of the equipment or machinery, the type of service required, or any other circumstances which may necessitate the next service to be delayed or brought forward in time. The use of smart electronic devices (eg. smartphones) to monitor a future service date can thus give rise to over-servicing or under-servicing of an item of machinery or equipment. Such methods are also problematic in instances where the owner loses the electronic record stored in devices in respect of which relevant service dates have been entered.

In many industries, keeping records regarding daily, monthly and/or annual checks is a legal requirement. Recording measurements to ensure correct oil level, coolant levels, engine hours, crew/staff, etc, may need to be checked and recorded daily. Conventional means of recording this information is a log book which is to be completed and kept for a period of time. The ability to have these records readily on hand, accessible from anywhere and able to be displayed in a format that is easily readable and printable if required would be highly beneficial.

The present invention seeks to mitigate the problems discussed herein, or at least seeks to provide an alternative solution to problems associated with existing methods of monitoring and tracking service requirements of equipment and machinery. More particularly, the present invention seeks to provide an alternative use of a data communications network to assist users to efficiently maintain apparatus whilst also avoiding inefficient use and utilisation of computing resources including data communications network resources which is a finite resource that is increasingly consumed by data communications devices.

The reference to any prior art in this specification is not, and should not be taken as, an acknowledgement or any suggestion, that the prior art forms part of the common general knowledge.

### SUMMARY OF THE INVENTION

In one aspect, the present invention provides a data communications network including connected data communications devices and method of operating same to assist a user with respect to servicing or maintaining an apparatus, the method including, receiving identification details regarding the apparatus and upon receipt of same, performing, using one or more artificial intelligence techniques, a search of available resources to identify one or more items matching the apparatus, providing, for display on a data communications device associated with the user, a listing of all available matching items identified by the one or more processors, receiving a selection from the user from the listing regarding the one or more items that match the apparatus for which the user seeks servicing or maintenance assistance, based on the received selection, retrieving a copy of one or more service or maintenance documents relating to the apparatus and identifying, using one or more natural language processing techniques, guidance within the document(s) regarding servicing or maintenance of the apparatus, initiating one or more relevant queries directed to the user regarding the previous use, service and/or maintenance of the apparatus to determine, using one or more natural language processing techniques applied to the responses(s) received from the user, a current servicing or maintenance status of the apparatus, based upon the response(s) received from the user in response to the one or more queries initiated by the one or more processors, and said guidance regarding service or maintenance of the apparatus, establishing a servicing or maintenance schedule or a modification to an existing servicing or maintenance schedule for the apparatus, and providing one or more service or maintenance notifications to the data communications device associated with the user regarding service or maintenance requirements applicable to the apparatus according to the established or modified schedule.

In an embodiment, the one or more service or maintenance documents include one or more of a user manual, a service or maintenance manual, or a manufacturer's instruction.

In an embodiment, the one or more artificial intelligence techniques used to establish or modify a service or maintenance schedule for the apparatus includes a predictive analytics algorithm that, in addition to analysing the response(s) received from the user and the guidance regarding service or maintenance of the apparatus, analyses additional inputs including one or more of, data received from hardware associated with the apparatus, historical servicing and/or maintenance data, meteorological data, apparatus usage statistics including usage trends, user preferences, user feedback, and user habits with respect to use of the apparatus.

In an embodiment, the hardware associated with the apparatus includes one or more sensors or internet of things (IoT) devices, and the method further includes, detecting, based on data received from the sensor(s) and/or IoT devices, abnormalities in the operation of the apparatus, and generating an alert regarding the detected abnormality and the need for attention to reduce the prospects of failure or damage to the apparatus.

In an embodiment, the one or more artificial intelligence techniques used to establish or modify the service or maintenance schedule includes Google DeepMind or variations thereof.

In an embodiment, interactions with the data communications device of the user, including initiating one or more relevant queries to the user, receiving responses thereto, and providing one or more service or maintenance notifications to the data communications device, are facilitated by the use of a conversational interface implementing one or more artificial intelligence techniques.

In an embodiment, the one or more artificial intelligence techniques used to provide the conversational interface includes ChatGPT or variations thereof.

In an embodiment, the method further includes, upon retrieving a copy of the document(s) relevant to the apparatus, providing a copy of the document(s) to the user.

In an embodiment, the available resources include the internet or one or more external databases, eg. databases associated with service/maintenance entities, manufacturers, etc.

In an embodiment, the identification details regarding the apparatus include any one or more of, a product type, a brand name, a model number, a product or serial number, a part number, a date of manufacture, and service/maintenance agent details.

In an embodiment, the method further includes, based upon issuance of the service or maintenance notification to the data communications device associated with the user, prompting the user to establish a work order to be issued to an entity that provides goods and/or services capable of addressing the service or maintenance requirement of the apparatus, or based upon issuance of the service or maintenance notification to the data communications device associated with the user, automatically generating a work order to be issued to an entity that provides goods and/or services capable of addressing the service or maintenance requirement of the apparatus.

In an embodiment, the method further includes, automatically, or based upon an instruction received from the user, dispatching the work order to an entity capably of fulfilling the work order that is either selected by the user or automatically selected.

In an embodiment, an entity capable of fulfilling the work order is selected based on one or more of, the location of the user, the location of the entity, credentials of the entity including qualifications, and a track record of the entity.

In an embodiment, the method further includes, receiving a response to the issued request from an entity of the one or more entities, wherein the response includes acceptance or rejection of the request and additional details including, a proposed commencement date and time for the service or maintenance task, an estimated completion date and time for the service or maintenance task, and an estimate of fees (eg. quotation) for completing the maintenance task.

In an embodiment, the method further includes, based upon the entity accepting the work order and the user accepting the proposed commencement date and time, the estimated completion date and time, and the estimate of fees, issuing the work order to the entity, based on the work order being issued to the entity, tracking the progress of the work order, eg. to ensure that the work order is timely completed and/or is completed within service/maintenance guidance requirements.

In an embodiment, tracking the progress of the work order includes one or more of, receiving task completion updates from the user and/or the entity completing the service or maintenance task, and receiving data from one or more sensors associated with the apparatus on which the service or maintenance task is being performed.

In an embodiment, the method further includes, providing the user and the entity assigned to complete service or maintenance tasks with the ability to upload information including notes recorded during the servicing or maintenance of the apparatus, the notes including one or more of written text, images, video and voice recordings, thereby establishing a historical record regarding servicing or maintenance of the apparatus. Notes may be manually uploaded or automatically generated, and may include data such as running temperatures for engines and generators, hours of use, kilometres of use, etc.

In an embodiment, the method further includes, providing a reporting feature enabling the user to generate and retrieve a report regarding the apparatus including the servicing or maintenance history for the apparatus (eg. service history logs) which includes any notes recorded during past servicing and/or maintenance. In this embodiment, a clear and concise overview of the apparatus monitored may be provided, including the current status of service/maintenance tasks.

In another embodiment, maintenance process optimization may be used to analyze service and maintenance data and identify potential opportunities to improve the service or maintenance process to achieve an optimal result. In this instance, optimizing the servicing or maintenance process may reduce the frequency of service/maintenance tasks and increase the efficiency of operation of the apparatus by maximizing availability and minimizing downtime for service/maintenance.

Similarly, spare parts and inventory management may be optimized with the use of artificial intelligence techniques. In one embodiment, the network provides alerts or notifications to users to inform them regarding a forthcoming requirement with respect to spare parts for facilitating future service/maintenance tasks.

In another aspect, the present invention provides a computer-implemented method for enabling a user to service or maintain an apparatus, the method including, receiving, by one or more processors, identification details regarding the apparatus and upon receipt of same, performing, using one or more artificial intelligence techniques, a search of available resources to identify one or more items matching the apparatus, providing, by one or more processors, for display on a data communications device associated with the user, a listing of all available matching items identified by the one or more processors, receiving, by one or more processors, a selection from the user from the listing regarding the one or more items that match the apparatus for which the user seeks servicing or maintenance assistance, based on the received selection, retrieving, by one or more processors, a copy of one or more service or maintenance documents relating to the apparatus and identifying, using one or more natural language processing techniques, guidance within the document(s) regarding servicing or maintenance of the apparatus, initiating, by one or more processors, one or more relevant queries directed to the user regarding the previous use, service and/or maintenance of the apparatus to determine, using one or more natural language processing techniques applied to the responses(s) received from the user, a current servicing or maintenance status of the apparatus, based upon the response(s) received from the user in response to the one or more queries initiated by the one or more processors, and said guidance regarding service or maintenance of the apparatus, establishing, by one or more processors, a servicing or maintenance schedule or a modification to an existing servicing or maintenance schedule for the apparatus, and providing, by one or more processors, one or more service or maintenance notifications to the data communications device associated with the user regarding service or maintenance requirements applicable to the apparatus according to the established or modified schedule.

In a further aspect, the present invention provides a non-transitory computer-readable medium including computer instruction code stored thereon, that when executed on a computer, causes one or more processors of the computer to perform the steps of, receiving identification details regarding the apparatus and upon receipt of same, performing, using one or more artificial intelligence techniques, a search of available resources to identify one or more items matching the apparatus, providing, for display on a data communications device associated with the user, a listing of all available matching items identified by the one or more processors, receiving a selection from the user from the listing regarding the one or more items that match the apparatus for which the user seeks servicing or maintenance assistance, based on the received selection, retrieving a copy of one or more service or maintenance documents relating to the apparatus and identifying, using one or more natural language processing techniques, guidance within the document(s) regarding servicing or maintenance of the apparatus, initiating one or more relevant queries directed to the user regarding the previous use, service and/or maintenance of the apparatus to determine, using one or more natural language processing techniques applied to the responses(s) received from the user, a current servicing or maintenance status of the apparatus, based upon the response(s) received from the user in response to the one or more queries initiated by the one or more processors, and said guidance regarding service or maintenance of the apparatus, establishing a servicing or maintenance schedule or a modification to an existing servicing or maintenance schedule for the apparatus, and providing one or more service or maintenance notifications to the data communications device associated with the user regarding service or maintenance requirements applicable to the apparatus according to the established or modified schedule.

Accordingly, the data communications network and method of the present invention enables users to download information pertaining to equipment or machinery they own and/or manage and in addition to receiving current copies of documentation including user manuals and/or maintenance guidelines, thereby obtaining and storing copies of relevant documentation whilst they are available, the data communications network and method provides the user with maintenance alerts and guidance regarding how to correctly maintain the apparatus for optimal performance and/or longevity of the apparatus.

More particularly, the data communications network and method provides users with the ability to create work orders in response to maintenance notifications and to record all relevant details regarding the completion of a work order confirming that the maintenance task has been performed.

It will be appreciated that by consolidating actions relating to maintenance of equipment or machinery including the ability to record and monitor dates for maintaining and servicing equipment or machinery, and functionality for the generation of reports, service requests and alerts/notifications in a single online platform, saves time and effort on the part of users who would otherwise be required to spend significant time and effort locating various hardcopy and online documents, including purchase receipts, service notifications, warranties etc., when attempting to ascertain past or future dates associated with maintaining their equipment or machinery.

Accordingly, the network and method of the present invention not only saves time and effort on the part of users, but also avoids users incurring costs to repair their equipment or machinery, or purchasing new/replacement parts/items of equipment or machinery, as a result of a failure to properly service and maintain their equipment or machinery and which could otherwise be avoided.

The network and method of the present invention also conserves computing processing and networking resources, since a significant amount of searching using the data communications network by an individual is avoided since there is no need to independently search for records and documents to establish service/maintenance timeframes. The network and method of the present invention automatically uploads information, records and relevant dates and generates alerts/notifications for the user regarding an approaching date for servicing their equipment machinery with these automated steps significantly conserving capturing finite resources and particularly the resource of the data communications network.

### BRIEF DESCRIPTION OF THE DRAWINGS

Embodiments of the invention will now be described in further detail with reference to the accompanying Figures in which:

FIG. 1 provides an overview of a data communications network according to an embodiment of the present invention showing, in particular, the interaction of various network components;

FIG. 2 illustrates a diagram associated with an exemplary server component of the network illustrated in FIG. 1;

FIG. 3 illustrates an exemplary flow diagram of a process that enables a user to download and install a software application, and subsequently access, or register to use, the software application for interaction with the network illustrated in FIG. 1, including to capture identification details relating to an apparatus;

FIG. 4 illustrates an exemplary user interface displaying a listing of all available matching items identified based on the identification details submitted in relation to the apparatus, which enables the retrieval of documentation relevant to the apparatus;

FIG. 5 illustrates an exemplary flow diagram of a process that enables relevant queries to be directed to the user regarding the use, service and/or maintenance of the apparatus in order to establish a maintenance schedule for the apparatus based on the user's response, and the generation of maintenance notifications which enable users to initiate a work order and issue requests to relevant parties to fulfil the work order; and

FIG. 6 illustrates an exemplary flow diagram of a process that enables the user to view progress relating to work order fulfilment, and to record and/or access reports, notes, etc regarding a maintenance history for the apparatus.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth to provide a better understanding of the present disclosure. It will be readily apparent, however, that the current disclosure may be practiced without limitation to the specific details. In other instances, some features have not been described in detail to avoid obscuring the present disclosure.

According to an embodiment, the present invention relates to a computer-implemented data communications network and method for assisting a user (30) to maintain an apparatus (55), eg. an item of machinery or equipment, which in the example shown in the Figures is an agricultural machine. The user (30) may be an operator of the apparatus (55), a mechanic or similar service provider assigned to service or regularly maintain the apparatus (55), or a manager assigned to monitor the apparatus (55). It is to be understood that the apparatus (55) can be any type of apparatus that requires ongoing maintenance or service, and is not necessarily limited to agricultural machinery.

Maintenance typically involves work that is done regularly on an item of machinery or equipment as a means of preventative care, eg. in accordance with a maintenance schedule. Servicing typically involves work performed on an item of machinery or equipment outside of a regular maintenance schedule, eg. to repair or replace parts, but may also include preventative care servicing. Despite the abovementioned differences, the words “service” and “maintenance” and variations thereof are used interchangeably herein, meaning that reference to one is not intended to exclude the other.

The data communications network and method provide a platform that hosts a computer-executable software application (40), wherein the application (40) is accessible by a plurality of users (30) who may search for, and download, information pertaining to equipment or machinery they own and/or manage, and are provided with automatically generated maintenance notifications (80) including guidance regarding how to correctly maintain the apparatus (55) for optimal performance and/or longevity. The generation of maintenance notifications (80) enables users (30) to further create work orders (85) in response to the notifications (80), and to record all relevant details regarding the fulfilment of work orders (85) confirming that service and/or maintenance tasks have been completed. The network utilises a central server (20) in communication with data communication devices (50) associated with each user (30).

The central server (20) maintains one or more processors and/or databases for performing functions, including receiving identification details regarding the apparatus (55) (e.g. a brand name, product number, model number, date of manufacture, or service agent details) and upon receipt of same, searching available resources (e.g. across the internet or one or more external databases (68) including databases associated with service/maintenance entities, manufacturers, etc) to identify one or more items matching the apparatus (55). The user (30) may subsequently be provided with a listing (170) of all available matching items identified by the server (20), and the user (30) may select an item from the results that best matches the apparatus (55) for which the user (30) seeks service/maintenance assistance.

Based on the user selection, a copy of a service user manual and/or maintenance manual, or any other document (70) relevant to the apparatus (55), may be retrieved, with a copy optionally provided to the user (30). Additionally, relevant queries may be initiated and directed to the user (30) regarding the previous use, service and/or maintenance of the apparatus (55) to determine a current maintenance status of the apparatus (55). Based upon responses received from the user (30) in response to queries, and further based upon the manufacturer's guidance regarding service or maintenance of the apparatus (as stated, for example, in the documentation (70)), a service/maintenance schedule (75) is established for the apparatus (55) according to stored pre-defined parameters for the apparatus (55). This gives rise to the provision of one or more maintenance notifications (80) to the user (30) regarding service/maintenance requirements applicable to the apparatus (55) according to the schedule (75).

Skilled readers will appreciate that the platform provides users (30) with the ability to access relevant information regarding the service/maintenance requirements of an apparatus (55) without the need to understand the particular requirements of the apparatus (55) or the need to remember due dates for such servicing/maintenance. In other words, through utilization of the platform and software application (40), there is no longer a requirement for the user (30) to actively check servicing/maintenance requirements for their machinery and/or equipment or to proactively manage same, since service/maintenance notifications (80) are automatically generated and transmitted to the user (30) who may subsequently initiate work orders for the fulfilment of same.

Furthermore, the present platform takes into account additional parameters which a user (30) may not necessarily take into account or may not be equipped to take into account due to limitations associated with the human brain and/or conventional maintenance notification methods, including factors such as an amount of use of the apparatus (55), type of service/maintenance, and/or additional circumstances which may necessitate a particular service/maintenance task being delayed or being brought forward in time for example. Furthermore, the platform and software application (40) provides a means to achieve the above whilst preserving computer processing and memory resources.

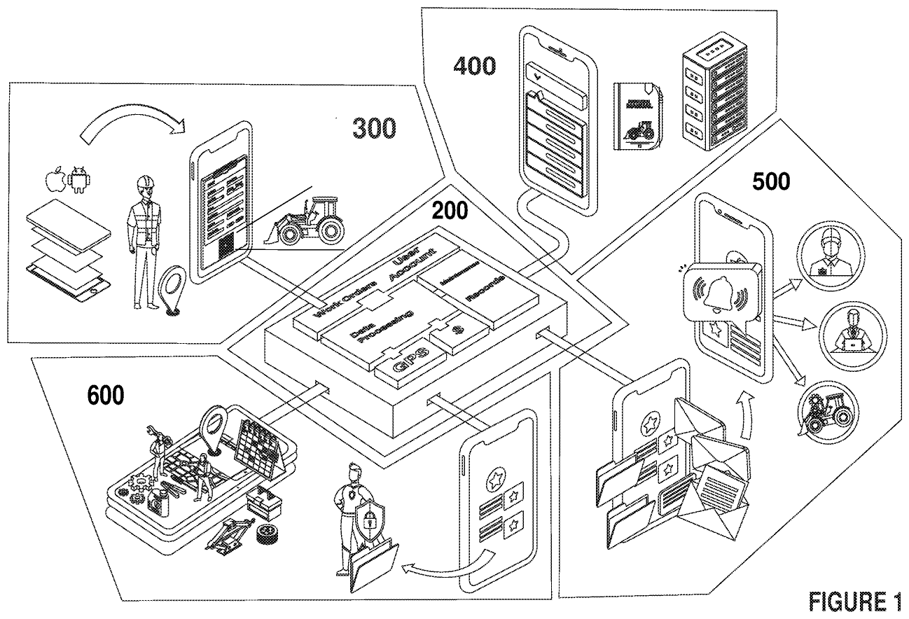

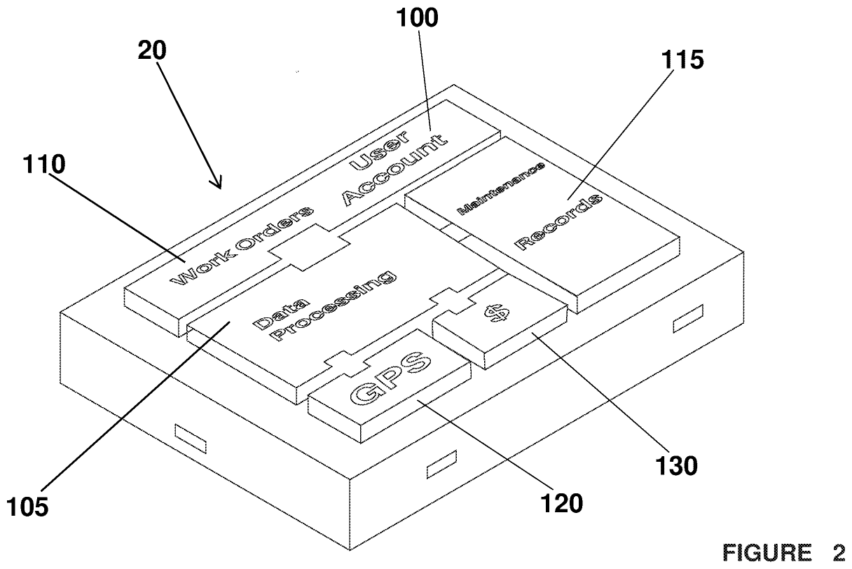

FIG. 1 is divided into Segments which are further expanded in subsequent FIGS. 2-6. In particular, Segment 200 of FIG. 1 shows the server component (20) with which the software application (40) operating on each data communications device (50) is configured to communicate. It will be apparent to the person skilled in the relevant field of technology that the software application (40) may be a mobile application or a web application and that, similarly, data communication devices (50) utilised by users (30) may be portable devices or fixed location computing devices. Examples of portable devices include mobile phones, computer tablets and smart glasses, and examples of fixed location computing devices including work stations and personal computers. The server component (20) is additionally detailed in FIG. 2.

The skilled person will further appreciate that the steps described herein may be executed by the devices (50), wherein such operations are facilitated by the software application (40) operating on each device (50). According to another implementation, the server (20) may be programmed to provide all, or most, of the processing functions described herein, where they cannot be provided locally on the user devices (50) or where it may be commercially or technically impractical to implement such arrangements. In other words, the steps described herein as performed by a device (50) or a component thereof, may be associated with hardware that is located externally of the device (50) such as the remote central server (20) for example (i.e. in a distributed architecture). Different arrangements are possible in this regard, and alternate variations will be apparent to the person skilled in the relevant field of technology.

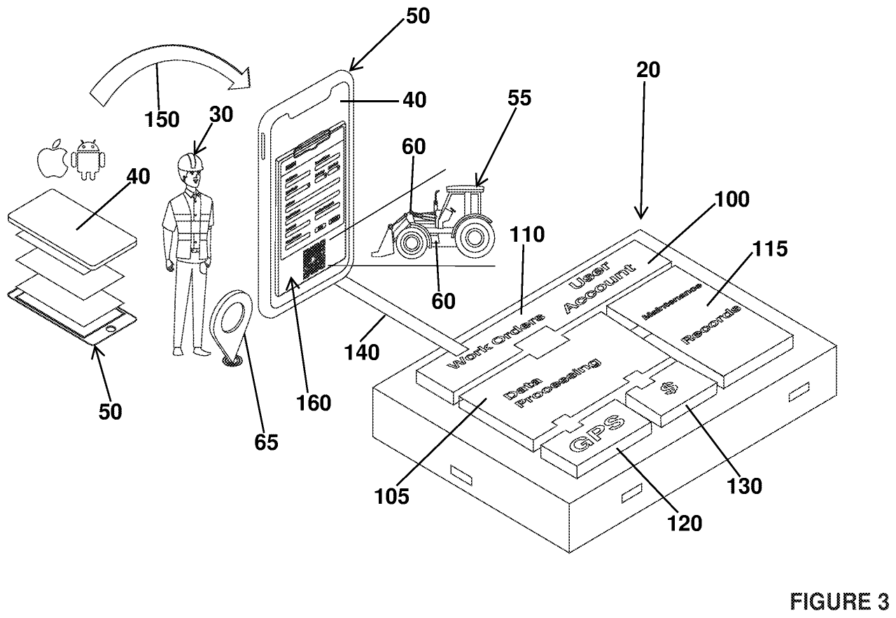

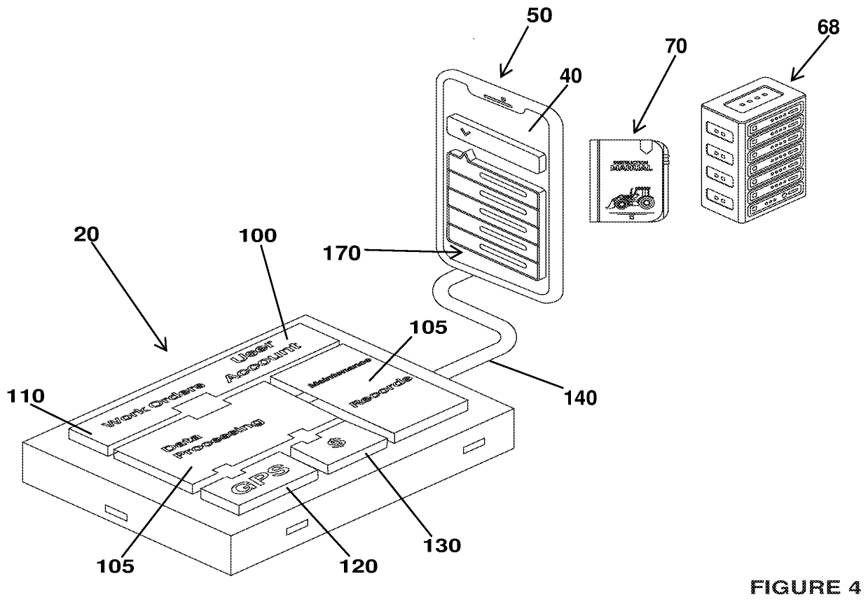

Segment 300 of FIG. 1 shows a user (30) utilizing interface (160) to download and install the application (40) and subsequently access the application (40) to establish an account, and to capture and/or upload identification details regarding the apparatus (55), as further detailed in FIG. 3. Segment 400 of FIG. 1 illustrates interface (170) providing users (30) with the ability to search available resources to identify one or more items matching the apparatus (55), with a listing of all available matching items provided to the user (30) thereby enabling the user (30) to make a selection regarding one or more items that match the apparatus (55) for which the user seeks service/maintenance assistance, and retrieve a copy of relevant documentation (70), as further detailed in FIG. 4.

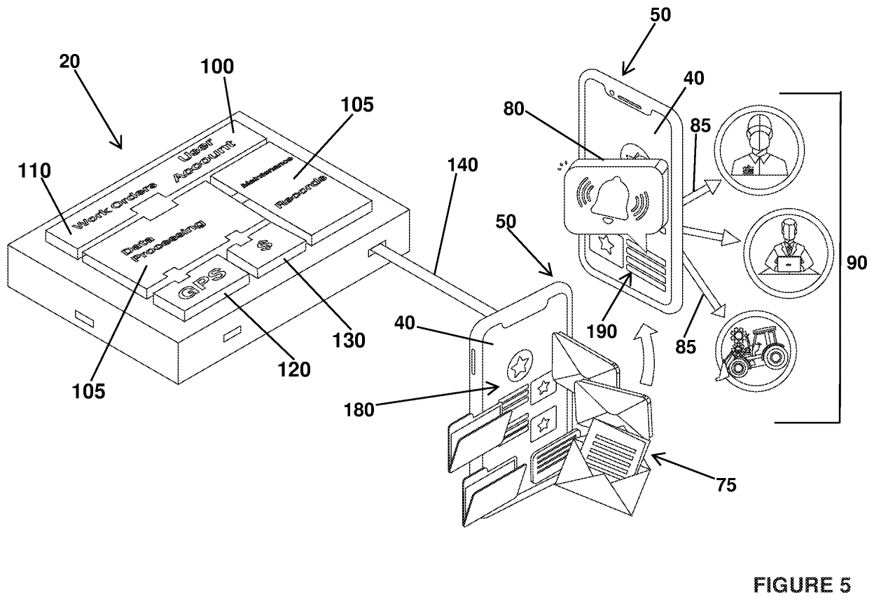

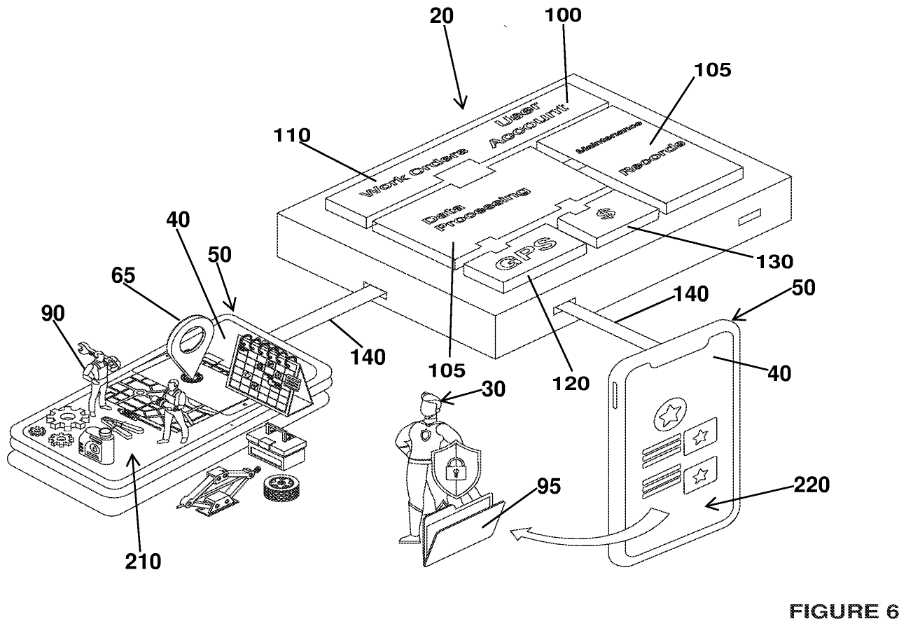

Segment 500 of FIG. 1 illustrates how a maintenance schedule (75) is generated based on transmitting and receiving responses to queries from the user (30) in relation to previous use, service and/or maintenance of the apparatus (55), as well as the provision of maintenance notifications (80) to the user (30) which ultimately enable the user (30) to create one or more maintenance work orders (85) to be fulfilled by one or more entities (90), as further detailed in FIG. 5. Finally, Segment 600 of FIG. 1 illustrates how the user (30) may monitor progress with respect to fulfillment of work orders (85) by the one or more entities (90) who are appropriately qualified to complete the maintenance, as well as record notes for the purpose of establishing a historical record (95) regarding maintenance history for the apparatus (55), as further detailed in FIG. 6.

As mentioned above, FIG. 2 shows in greater detail Segment 200 of FIG. 1 and, in particular, FIG. 2 shows the server component (20) which includes infrastructure upon which the platform of the presently described embodiment operates. The infrastructure may be local or cloud-based.

The central server (20) may operate one or more computer processors and maintain one or more databases to enable the following functionality and/or storage:
User account register (100) storing user details such as name, age, address, location (65), contact details, identifiers such as driver's license or passport details of the user (30), and any additional data which may be relevant for the purpose of identifying each user (30). Where possible, such details may be verified using identification verification services. The user account register (100) may also store details relating to registered apparatus (55) which the user (30) has registered through the platform for servicing and/or ongoing maintenance;
Data processing functionality (105) for processing user input commands and additional data received, and to generate relevant outputs for display. For example, the data processing functionality (105) may be responsible for searching available resources, including locally or from a remote or external database (68), to identify apparatus to provide for display in the listing interface (170), retrieving copies of relevant documentation including user manuals, etc (70) relevant to the apparatus (55), initiating queries to the user (30) and processing responses thereto through interface (180) based on the queries and manufacturer's guidance from documentation (70), and subsequently, based upon such processing, establishing a service/maintenance schedule (75) according to pre-defined parameters for the apparatus (55). The functionality (105) may also be responsible for issuing service/maintenance notifications (80) to users (30) according to the schedule (75), and processing work orders (85) and issuing automatic requests to relevant third parties (90) to fulfil the work orders (85) (noting that the work order steps may alternatively be achieved manually by the user (30));
Work order database (110) storing historical and current work orders (85) established by users (30) or automatically established through use of the data processing functionality (105), the work orders (85) undergoing regular updates based upon feedback regarding certain service/maintenance tasks that have been progressed or completed;
Maintenance records (115) storing notes, reports, etc, with respect to the service/maintenance history of particular apparatus (55) (accessible via interface (220)). This database (115) may also store additional information including pre-defined parameters for each apparatus (55) upon which the maintenance schedules (75) are based. Retrieved documents (75) may also be classified and categorized when stored in database (115), enhancing the network's capacity to locate and use them thereby enabling convenient retrieval of maintenance manuals for future maintenance tasks;
GPS location database (120) storing details relating to the location (65) associated with users (30) (e.g. fixed and/or current locations) as well as the location of apparatus (55) and/or service/maintenance sites;
Payment gateway functionality (130) enabling financial transactions to be completed utilising the platform including payment of subscription fees (if applicable), in addition to allowing payment from users (30) to third parties (90) engaged to fulfil work orders (85) distributed by users (30) in exchange for services.

FIG. 2 also depicts server (20) configured to enable communication (140) with the user devices (50) and, in particular, the software application (40) operating on each user device (50). Such communications may occur via the internet or other similar data communications network.

FIG. 3 shows in greater detail Segment 300 of FIG. 1 and, in particular, the steps associated with a user (30) downloading and installing software application (40) which may be achieved by downloading the application (40) from an application store. Each user (30) may create an account using the application (40) and the account information may be stored in the account register (100). As described above, the user account register (100) may capture information sufficient to enable each user (30) to be correctly identified.

The process of installing the application (40) is indicated by arrow (150), and interface (160) is also shown in FIG. 3 which allows the user (30) to download and install the application to access the functionality thereof, including to create and maintain a user profile and capture and/or upload the identification details relating to an apparatus (55) owned or managed by the user (30). Accordingly, once the application (40) has been accessed by a user (30), the user (30) may be presented with an interface identical or similar to interface (160) to allow the user (30) to create and maintain their account and profile, including providing the user (30) with the ability to add/edit details. Upon uploading sufficient information, including in relation to the apparatus (55), each user (30) will be successfully registered such that the user (30) becomes a registered user and the apparatus (55) becomes a registered apparatus. The user (30) may subsequently utilise the functionality of the application (40), which may be in accordance with a subscription level of the user (30).

In addition to capturing identification details relating to the apparatus (55), the user (30) may also upload details relating to any associated components of the apparatus (55) that may affect the service/maintenance schedule (75) established for the apparatus (55). For example, the apparatus (55) may have one or more sensors (60) attached, wherein the sensors are configured to determine abnormalities in the operation of the apparatus (55), and such sensors may be configured to automatically provide data to the central server (20). Data from sensors (60) may impact the service/maintenance schedule (75) generated for the apparatus (55), as described in greater detail below.

FIG. 4 shows in greater detail Segment 400 of FIG. 1 and, in particular, the display (170) of a listing of all available matching items identified by the server (20) based upon the received identification details and additional details relating to the apparatus (55) based on a search of available resources (including external database (68) if required) to identify one or more items matching the apparatus (55)). It will be appreciated that based upon a selection from the user (30) of a particular item from the listing, a copy of a service user manual and/or maintenance manual and/or any other document (70) relevant to the apparatus (55) may be retrieved. Whilst not shown, the software application (40) may provide a further interface in which such documentation (70) may be configured for viewing, downloading, etc, by the user (30).

One or more artificial intelligence techniques may be utilized to assist the searching of available resources to identify matching items, and to ensure that any document (70) retrieved will be appropriately analysed such that sufficient and relevant information is extracted from the document(s) (70) for the purpose of understanding the manufacturer's guidance regarding service/maintenance of the apparatus (55) during establishment of the service/maintenance schedule (75) for the apparatus (55). In addition, if the document (70) is presented to the user (30), it can be presented in an interesting and simple-to-read style, and the way in which the contents of the document (70) is presented may also depend upon user behaviour, preferences and previous interactions.

FIG. 5 illustrates Segment 500 of FIG. 1 in greater detail and, in particular, the use of a query/response interface (180) by the user (30) in which the user (30) may be provided with relevant queries regarding the previous use, service and/or maintenance of the apparatus (55), to establish a current service/maintenance status of the apparatus (55). Based upon the responses received from the user (30) via interface (180), as well as the manufacturer's guidance regarding service/maintenance of the apparatus (55) (as established through documentation (70) for example), a service/maintenance schedule (75) is automatically established for the apparatus (55) whereby the schedule includes fields that are pre-populated in accordance with pre-defined parameters for the apparatus (55). The additional interface (190) shown in FIG. 5 is a service/maintenance notification interface where, based upon the establishment of the maintenance schedule (75), one or more maintenance notifications will be displayed to the user (30) in order to provide the user (30) with information regarding service/maintenance requirements applicable to the apparatus (55) at a particular time according to the established service/maintenance schedule (75).

An example of where a service or maintenance task may be brought forward or delayed (as compared with a previously scheduled date that was generated based on a published service/maintenance guideline, or by a service provider such as a mechanic who has previously undertaken servicing and/or maintenance tasks on the apparatus (55)) is where a user (30) provides a response to a query relating to the use of the apparatus (55). If the user's response indicates that there has been unexpectedly heavy use of the apparatus (55), then the scheduled service/maintenance task may be brought forward. Similarly, if the user's response indicates that there has been unexpectedly light use of the apparatus (55), then the scheduled service/maintenance task may be delayed accordingly. It will be appreciated therefore that the scheduling of service/maintenance is dynamic and may be updated based on a variety of factors including, but not limited to, regular feedback provided by users who are prompted to provide such feedback including in relation to use of the apparatus (55), previous service/maintenance data, the received identification details, identified habits of the user with respect to use of the apparatus, and additional factors such as performance data for the apparatus (55).

Artificial intelligence and machine learning techniques such as those implemented by Google's DeepMind may be utilized to examine past maintenance data and to identify trends that enable the determination of the most appropriate next service/maintenance date, or preferred intervals for performing servicing/maintenance in respect of a particular apparatus (55). Artificial intelligence techniques may also be utilized to convey such information, including through the use of OpenAI's ChatGPT functionality, to clearly convey the results to users ensuring that they comprehend the need for prompt attention. For example, a driver's driving habits may be analysed along with the vehicle's performance data (retrieved from one or more sensors mounted on the vehicle), and the owner of the vehicle may receive a message issued by the software application (40) recommending that a scheduled car servicing or maintenance be brought forward earlier or delayed until after a previously scheduled service/maintenance date or interval.

In this regard, artificial intelligence techniques may be utilized to ensure that a balance is achieved between underservicing and overservicing an apparatus (55) based upon factors such as those mentioned above, as well as additional factors that may include user preferences, usage statistics and environmental considerations.

It will be appreciated that the capabilities and performance of the software application (40) platform will be improved by incorporating AI techniques to assist users with apparatus maintenance, including based on enhancements in user interface, data processing efficiency, and predictive maintenance. For example, through the use of machine learning particularly with deep neural networks, enormous volumes of data including, for example, sensor data from apparatus (55) may be analysed, and the prediction of future malfunctions and service/maintenance requirements which may alter a currently scheduled service/maintenance task may be enhanced. For example, an engine's sensors might provide historical and real-time data that may be used to forecast when an engine would malfunction or require repair beyond what is typically scheduled. By preventing failures before they happen, this predictive maintenance functionality lowers maintenance costs and apparatus downtime.

By offering a natural language processing interface that enables users to respond to queries, such as equipment status queries, the predictive maintenance procedure may also be improved. For example, a user may enquire, “What's the current operational status of the generator?”. The use of the abovementioned predictive analytics techniques and historical data enables a thorough, readily comprehensible summary of the generator's condition, possible problems, maintenance recommendations, and the reasoning for same. Such technologies may also be utilized to personalize user interactions by analysing patterns of behaviour. For example, recommendations may be generated that take into account the user's preferences and previous answers to queries, and service/maintenance notifications and recommendations may be customized depending upon the user's engagement history with the network.

By combining a predictive analytics capability (such as that provided by Google DeepMind) with natural language processing (such as that provided by OpenAI's Chat-GPT), the service/maintenance schedules of users (30) may be dynamically modified and such users (30) may be alerted with a clear explanation regarding any revised service/maintenance plan. Advice may also be generated and provided to users (30) regarding possible consequences of not proceeding in accordance with a revised service/maintenance plan, eg. apparatus malfunction. The dynamic modification of a service/maintenance schedule may be based upon usage patterns, environmental conditions, maintenance history, etc, and may be accompanied by a forecast regarding the usage rate of the apparatus (55) which may cause the apparatus (55) to fail prior to its planned service/maintenance. The alert to the user (30) may also be accompanied by advice regarding preventative measures, including straight forward fixes, to prevent the apparatus (55) from failing.

With respect to environmental conditions, the platform may integrate with a bureau of meteorology or similar advisory entity in order to evaluate data generated in respect of meteorological conditions which may subsequently influence the generation/modification of a service/maintenance schedule (75) for an apparatus (55) which will experience a particular weather event, as well as the generation of a work order (85). For example, a suggested service/maintenance schedule for outdoor equipment may be modified in anticipation of a severe winter, accounting for the increased wear from freezing temperatures and ice. In these circumstances, users (30) and entities (90) engaged to perform service/maintenance may be provided with additional guidance and recommendations regarding service or maintenance requirements in view of such weather conditions.

User feedback in relation to retrieved documents (75) may also be useful with respect to updating documents (75) to ensure that any service/maintenance instructions included in the documents (75) are as accurate and helpful as possible. Updates to such documents may also be based upon an analysis of the outcome of service/maintenance tasks as detected by equipment hardware and other factors described herein such as usage trends.

Once a date or potential dates for carrying out a service/maintenance task or action, or modifications thereto, have been established, one or more work orders (85) may subsequently be generated, either automatically via the platform or manually by the user (30). In this regard, the work order(s) (85) may be distributed to one or more relevant parties (90) (e.g. maintenance personnel, technicians, mechanics, etc) to fulfil the work order by completing the maintenance task(s). Accordingly, the interface (190) provides the user (30) with the ability to enter details and/or instructions to issue a request to fulfil work order(s) (85) to entities (90) who are appropriately located and qualified to complete such tasks, and the user (30) may receive responses from the entities (90) including acceptance of the work order and/or relevant details regarding the proposed completion of the service/maintenance task along with quotations for performing same.

As mentioned above, the generation of work orders (85) may be automatic and this may be assisted by one or more artificial intelligence techniques. For example, by taking into account variables such as service provider availability and urgency, optimisation algorithms may be used to ensure that maintenance work orders are generated, dispatched and subsequently tracked effectively. For example, if a user (30) establishes a work order (85) to fix a conveyor belt that is not functioning correctly, artificial intelligence technique(s) may be utilized to gather the required information and verify the user request, and also optimize the service process by scheduling the work according to technician schedules and urgency. Additional factors which may influence the creation and dispatch of a work order include analyses of historical data collected with respect to related problems and predictive service/maintenance needs, hence the scheduling of the word orders may be adjusted in an attempt to achieve an optimal outcome. Users (30) may also be prompted with questions to ensure that all relevant information has been captured for the establishment of a work order (85). Work orders (85) may also be arranged according to a priority allocated to the word order, which may be based on, for example, the urgency and role of the apparatus (55), eg. how crucial a piece of equipment is in a production line.

At the same time a work order (85) is generated, a user (30) may be provided with additional instructions to assist the service/maintenance process including, for example, to order spare parts based on a forecast of future spare part requirements. Artificial intelligence techniques may be utilized to forecast a probability that certain parts will require replacement in the near future according to factors such as expected failure rates and current lead times.

Through the use of AI techniques, the selection of parties (90) to whom to work orders (85) are issued may also be facilitated. For example, the credentials and past performance record of registered service providers may be analysed, with those having the most relevant credentials and best historical performance record more likely to be selected to complete work orders (85), with service provider options also presented to users (30) for final selection. In one example, a homeowner may need to service their air-conditioning system. By utilizing the abovementioned artificial intelligence techniques (eg. the analytics capabilities of Google DeepMind and the natural language processing capabilities of OpenAI's ChatGPT4), a number of highly rated air conditioning service providers may be presented to homeowner along with relevant information including costs and availability, to assist the homeowner in making an informed choice.

Additionally, such techniques may also facilitate making arrangements for entities (90) to attend the location at which the apparatus (55) is located. In this regard, communications may be issued to/between users (30) and providers (90) to schedule service/maintenance tasks at mutually convenient times. In one example, a gym owner may prefer to plan fitness equipment maintenance during off-peak hours which may be determined according to an analysis of the equipment usage patterns, and to minimize disruption, any work order (85) generated may take into account the gym owner's preference and only issue work orders to providers (90) with capacity to provide services during the off-peak hours.

The generation of a service/maintenance schedule (75) may require the use of text recognition tools to process text from retrieved documentation (70) as well as the responses from users (30) such that the text is interpreted and converted into an appropriate maintenance schedule (75) for the apparatus (55) according to pre-defined parameters. In this regard, complicated technical documents may be simplified into straight forward directions using, for example, artificial intelligence techniques to provide step-by-step assistance if a user is uncertain with respect to performing a particular maintenance activity. User interaction is also likely to be enhanced based on providing users (30) with substantially real-time reactions to user queries, concerns and feedback.

As described earlier, additional factors that may also have an effect on the service/maintenance schedule (75) include data received from hardware such as one or more sensors (60) or internet of things devices (not shown) associated with the apparatus (55). In one particular implementation, the analysis of sensor data may then be used to determine abnormalities in the operation of the apparatus (55) and in such instances, an alert regarding the abnormality and the need for attention to reduce the prospects of failure, degraded performance or detrimental damage may be generated and sent to the user (30) (e.g. via text message, email, push notification or as part of a service/maintenance notification (80)).

Examples of indicators that may generate such an alert include real time data analysis indicating that there is wear in crucial components that may result in component failure. In order to avoid unplanned downtime, maintenance crew and other personnel may be notified and urgent examination and replacement of problematic components may be requested.

FIG. 6 shows in greater detail Segment 600 of FIG. 1 and, in particular, a work order fulfilment interface (210) that enables the user (30) to track progress with respect to the fulfilment of work orders (85) by one or more relevant parties (90). The skilled addressee will appreciate that this interface provides users (30) with the ability to track such progress and ensures that the work order (85) is completed in a timely manner and/or based on other relevant parameters, eg. within service/maintenance guidance requirements.

The additional interface (220) shown in FIG. 6 enables the recordal of notes, records, reports, etc by the user (30), and/or entities (90) performing the scheduled service/maintenance tasks, for the purpose of establishing a historical record (95). Notes may be recorded manually or automatically and may include additional information relating to the apparatus (55), including by way of example, running temperatures for engines and generators, hours or kilometres of use, etc. This information may be used by the data communications network to analyse the maintenance parameter(s) of greatest importance regarding optimal performance of the apparatus (55). The notes may also include uploaded images, documents or voice recordings to form part of the historical record regarding maintenance of the apparatus (55).

A user-friendly interface such as interface (220) may be provided to entities (90) such as technicians who may enter service or maintenance notes, and with the use of artificial intelligence techniques, such notes may be analysed to find patterns or recurring problems. Future service/maintenance recommendations and predictive maintenance models will benefit from such information. In one example, a technician may repair a commercial espresso machine and uses ChatGPT or similar AI tool to enter thorough notes regarding the work completed. Such notes may subsequently be analysed using, for example, Google DeepMind or other similar AI tool to modify the machine's future service/maintenance schedule (75). Detailed reports in relation to service/maintenance records and history may also be generated for the benefit of the user (30) and/or the goods/service provider (90).

It will be appreciated that by storing such information, the user (30) or any other interested party may easily extract such information for the purpose of conducting apparatus reviews, staff reviews, analytics, etc. In this regard, the interface (220) may also provide the ability to generate relevant reports regarding any particular apparatus (55) or particular user (30/90), including in relation to the maintenance history for a product. Such reports may include service history logs and attached images with descriptions. A clear and concise overview of all apparatus (55) monitored by the data communications network may be provided including current status of maintenance tasks.

Potential opportunities to improve the maintenance process to achieve an optimal result may also be identified using the present platform, which may lead to benefits including reducing the frequency of maintenance tasks and increasing the efficiency of operation of the apparatus (55) by maximizing availability and minimising downtime for maintenance. Similarly, spare parts and inventory management may be optimised with the use of artificial intelligence techniques. According to one example, the data communications network may provide alerts and/or notifications to users (30) to inform them regarding forthcoming requirements with respect to spare parts for effecting future service/maintenance tasks.

Sensors and similar hardware may also be used to monitor progress of a particular service or maintenance task conducted by an entity (90). In this regard, by examining information from equipment sensors, and the service providers (90) themselves, up-to-date information regarding the status of work orders (85) may be generated and provided to users (30), including using one or more artificial intelligence models. In this way, users (30) may receive such updates which will provide transparency and assurance throughout the service/maintenance process. In one example, a manager of a restaurant may establish a work order (85) for a service provider (90) to purchase supplies for repairing a kitchen component. Based on real-time tracking technology, the manager may be provided with periodic updates regarding the service progress, including the technician's projected arrival date and time, and estimated completion date and time.

Where remote monitoring may be required for apparatus (55) operating in distant locations, a range of artificial intelligence techniques may be utilised to remotely monitor the condition of apparatus (55) and alert users regarding potential issues that, if timely addressed, may avoid serious problems and failures in respect of operation of the apparatus (55). For example, when monitoring apparatus in remote areas, the data communications network may use the assistance of UAV's (unmanned aerial vehicles) or UAS's (unmanned aircraft systems) (not shown) to assist with the collection of data regarding maintenance requirements with respect to the remotely operated apparatus (55). In one particular example, a drone, UAV or UAS may be pre-programmed with flight plans regarding preferred flight paths to travel to remotely located apparatus (55).

The use of such monitoring data may also be facilitated by the use of one or more artificial intelligence techniques, such that data from drones and similar monitoring apparatus may be analysed to check the condition of apparatus (55) in remote areas, and users (30) may be alerted to any faults that are interpreted from the data, allowing for prompt maintenance even in difficult to reach locations. In one example, wind farm turbines may be inspected using drones, and through the use of AI drone footage may be analysed for potential problems, wherein a maintenance crew may be appropriately notified when any one particular turbine requires service or maintenance, allowing for prompt repair.

The benefits of the present invention will now be evident to skilled readers including the ability of the platform to inform users via their preferred communication channel of impending service/maintenance requirements, hence ensuring that the user (30) does not overlook important service/maintenance dates. The recommendations provided to users may also suggest that scheduled service/maintenance be delayed or brought forward, eg. delayed in circumstances where an apparatus (55) is well-maintained and underutilized to avoid needless repair and incurrence of cost unnecessarily. Timely reminders along with additional useful information are presented to the user, and by continuously learning from service/maintenance results, future service/maintenance recommendations and forecasts may be enhanced.

Additional use examples include, but are not limited to:
A manager of medical equipment may request when the next maintenance is scheduled. In response, the user is provided with a date and an explanation regarding why a previously scheduled date has been modified, eg. in view of past maintenance data and patterns of recent equipment usage. For example, one or more artificial intelligence techniques (such as Google DeepMind) may be used to analyse equipment usage and condition data from integrated sensors to automate the tracking of maintenance requirements, and using additional AI techniques (such as OpenAI ChatGPT) the user may be provided with a user-friendly conversational interface;
A fitness centre manager responsible for the management of multiple treadmills may receive a notification that the treadmills need to be serviced earlier than expected in view of an analysis on the treadmills indicating heavy usage at a recent fitness challenge event, which may serve as the basis for the notification. For example, by using real-time data, one or more predictive models may be used to automatically modify maintenance plans, obviating the necessity for manual checks, and the manager may be notified of the change and the associated reasons;
An operator of a crucial piece of manufacturing may be alerted to a likely malfunction in the equipment, and a recommendation is provided to ensure preventive maintenance. For example, a failure prediction model may be used to predict such malfunctions, and reduce maintenance-related issues through the provision of early warnings and useful insights to the operator.
Artificial intelligence analysis may determine that some machines on a production line are over-serviced based on an analysis of the equipment maintenance history. A plant manager may receive advice regarding how to schedule future service/maintenance in order to minimize disruptions and optimize resource usage.

Throughout this specification, two specific artificial intelligence tools are referenced and described, namely, Google's DeepMind and OpenAI's ChatGPT. However, the present invention is not limited to these particular tools, and it will be understood that other similar tools could be used.

Google's DeepMind machine learning techniques enable analysis of enormous volumes of data from usage logs, maintenance records, and equipment sensors. With this research, downtime may be minimised and machinery longevity increased by accurately anticipating possible breakdowns or maintenance requirements. By proactively addressing problems, the predictive maintenance insights produced can minimise expense and maximise operational effectiveness.

The use of ChatGPT provides users with a means of communicating with the platform using natural language. This improves the system's usability and accessibility by enabling users to report problems, receive maintenance details, and access help in a conversational way. Natural language query processing and comprehension significantly enhances user experience.

The following represents exemplary computer software code for Google DeepMind and ChatGPT integration:

```
      from flask import Flask, request, jsonify import os
import os
import requests
app = Flask(_{——}name_{——})
# API keys are stored in environment variables for security
CHATGPT_API_KEY = os.environ.get(‘CHATGPT_API_KEY’)
DEEPMIND_API_KEY = os.environ.get(‘DEEPMIND_API_KEY’)
# Placeholder for
DeepMind integration
# Endpoint URLs
CHATGPT_URL = ‘https://api.openai.com/v4/chat/completions’
def call_chatgpt(prompt):
  “““
  Function to call ChatGPT API with a prompt and return the response.
  ”””
  headers = {
    ‘Authorization’: f‘Bearer {CHATGPT_API_KEY}’,
    ‘Content-Type’: ‘application/json’,
  }
  data = {
    “model”: “gpt-3.5-turbo”, # Adjust model as necessary
    “prompt”: prompt,
    “max_tokens”: 100,
    “temperature”: 0.5,
  }
  response = requests.post(CHATGPT_URL, json=data,
  headers=headers)
  if response.status_code == 200:
    return response.json( )[‘choices’[0][‘text’].strip( )
  else:
    return “Error: Unable to retrieve response from ChatGPT.”
@app.route(‘/maintenance_query’, methods=[‘POST’])
def maintenance_query( ):
  “““
  Endpoint for users to submit maintenance queries, which are
  processed by ChatGPT.
  ”””
  user_query = request.json.get(‘query’)
  chatgpt_response = call_chatgpt(user_query)
  return jsonify({“response”: chatgpt_response})
# Placeholder function for integrating DeepMind's predictive
maintenance insights
def get_predictive_maintenance_insights(equipment_id):
  “““
  Function to retrieve predictive maintenance insights for a specific
  piece of equipment.
  This is a placeholder demonstrating where and how you might
  integrate DeepMind's
AI insights.
  ”””
  # Here, you would use DEEPMIND_API_KEY to authenticate and
  call DeepMind's
predictive maintenance API.
  # This part is hypothetical and depends on the specific API
  interfaces provided by
DeepMind.
  return “Predictive maintenance insights for equipment ID:
  { }”.format(equipment_id)
if _{——}name_{——} == ‘_{——}main_{——}’:
  # Set the API keys in your environment variables for security.
  if not CHATGPT_API_KEY or not DEEPMIND_API_KEY:
    raise ValueError(”
```

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (eg. software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

A cloud platform that has strong security features, scalability, and high availability may be used to host the central server (20). As previously described, the server (20) may serve as the main hub for all AI analysis, user interactions, and data processing related to servicing/maintenance.

When integrating artificial intelligence techniques such as ChatGPT and Google DeepMind, an Application Programming Interface (API) may be utilized which may involve obtaining API keys or tokens required to authenticate API calls. Such API keys and tokens may be securely stored and managed so that they are not exposed inside the codebase.

Instead of hard-coding API keys or tokens into the source code of the application (40), they may be stored as environment variables. By following this procedure, the keys are shielded from disclosure in version control systems and binary distributions of the application.

A secrets management system such as Azure Key Vault, AWS Secrets Manager, or HashiCorp Vault may also be utilized for increased security. Sensitive data, such as API keys, can be safely managed and stored via these platforms. To further secure API key usage, secrets management solutions may include features such as audit logs, automated key rotation, and access control policies.

The portions of the software application (40) that need access to the API keys or tokens may be restricted to only those users or services required to have access to same in order to uphold the principle of least privilege. Access permissions may be reviewed and adjusted on a regular basis, particularly when team members join or leave projects or the architecture of the application (40) changes.

The API requests, including those to ChatGPT and Google DeepMind, may be sent using the HTTPS protocol which encrypts data whilst in transit and guards against interception of the API keys or tokens. To avoid inadvertently logging or displaying API keys or tokens in error messages or logs, error handling may also be incorporated into the application (40).

Monitoring how tokens or API keys are being used is also recommended to identify any unusual or unauthorised activity. For monitoring API usage, Google DeepMind and OpenAI both offer dashboards or logs. Tokens or API keys may be rotated on a regular basis and any time there is a risk that they could have been compromised.

“Use data” ingestion modules may also be used to gather and send sensor readings and usage statistics to the server (20) from the apparatus (55). IoT protocols such as MQTT or HTTPS for secure data transmission may also be used.

To make the incoming data formats compatible with AI models such as DeepMind, a data normalisation layer may be included. This may require properly encoded category data or conversion of sensor data into a standard format. Feature engineering scripts may be created to extract significant features from the normalised data as required by DeepMind's predictive maintenance models.

To obtain maintenance forecasts and insights, processed equipment data may be fed into predictive models using DeepMind's APIs. For fast access and historical analysis, predictions may be stored in a database or a caching layer may be implemented.

An interface may be provided that enables users (30) to share maintenance requests or instructions by use of a mobile or online application. Such requests may be processed using ChatGPT APIs to provide users with knowledge gleaned from DeepMind's analysis or to convert user commands into practical maintenance requests. ChatGPT's responses may be presented in an understandable and practical format for the end user, including, for example, actionable maintenance instructions or alerts.

Intuitive user interfaces may be provided for web or mobile applications so that users (30) may browse maintenance schedules, report concerns, and receive alerts for predictive maintenance, etc, with ease. Web sockets or push notification systems may be used to deliver service/maintenance alerts in substantially real time, alerting users to critical service maintenance requirements identified by, for example, DeepMind's prediction algorithms.

To encrypt data while it is in transit, HTTPS may be used for all communications. Further, “OAuth” may be used to grant users access to the maintenance system and to authenticate themselves. Routine system security audits may be conducted, encompassing API integrations, to safeguard confidential information and privacy of users (30).

To monitor user interactions, system performance, API usage, etc, extensive monitoring and logging may be used. Such information may be used for system optimisation and troubleshooting. Dashboards that offer up-to-date information on user engagement metrics, API performance, system health, etc, may also be included.

Methods for gathering and analysing user input to assist the AI models and user interface improving over time may also be used. Iterative improvements may be guided by feedback on the accuracy of predictive maintenance and the usability of the user interface.

Rate constraints may be enforced by Google APIs as well as OpenAI (ChatGPT). In this regard, responses may be cached when necessary, and exponential backoff techniques may be used to retry requests in the event that rate limit issues or temporary failures occur.

Error handling systems may be used which read and accordingly react to error messages from the APIs, in addition to identifying network problems and exceeding API limits. In order to provide real-time incident response, errors may be reported to a monitoring service that offers alerting features.

Real-time equipment data processing may be used for predictive maintenance. In this regard, real-time data import, processing, and analysis tools such as stream processing frameworks (Amazon Kinesis, Apache Kafka, etc.) may be utilized, which will make it possible for the data communications network to detect patterns or abnormalities that may identify a need for repair.

Data may be in multiple formats depending upon the kind of sensor or equipment used. Uniformity may be ensured by implementing a data normalisation layer, which facilitates the processing and analysis of the data using machine learning models. Algorithms for feature extraction may be created to emphasise data points that are most indicative of maintenance requirements.

Systems that enable user interactions, criticism, and maintenance results may be included to train AI models. In order to increase the precision and applicability of predictive maintenance insights over time, models may require retraining using fresh data that reflects the performance of the service/maintenance suggestions in the real world.

Methods for monitoring may be implemented that provide insight into the functionality, performance, and usage of the application's APIs as well as user interactions. Analysing metrics and logs may be important for understanding user behaviour and system performance in addition to operational monitoring.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A data communications network comprising connected data communications devices and method of operating same to assist a user with respect to servicing or maintaining an apparatus, the method comprising:
receiving identification details regarding the apparatus and upon receipt of same, performing, using one or more artificial intelligence techniques, a search of available resources to identify one or more items matching the apparatus;
providing, for display on a data communications device associated with the user, a listing of all available matching items identified by the one or more processors;
receiving a selection from the user from the listing regarding the one or more items that match the apparatus for which the user seeks servicing or maintenance assistance;
based on the received selection, retrieving a copy of one or more service or maintenance documents relating to the apparatus and identifying, using one or more natural language processing techniques, guidance within the document(s) regarding servicing or maintenance of the apparatus;
initiating one or more relevant queries directed to the user regarding the previous use, service and/or maintenance of the apparatus to determine, using one or more natural language processing techniques applied to the responses(s) received from the user, a current servicing or maintenance status of the apparatus;
based upon the response(s) received from the user in response to the one or more queries initiated by the one or more processors, and said guidance regarding service or maintenance of the apparatus, establishing a servicing or maintenance schedule or a modification to an existing servicing or maintenance schedule for the apparatus; and
providing one or more service or maintenance notifications to the data communications device associated with the user regarding service or maintenance requirements applicable to the apparatus according to the established or modified schedule.

2. The data communications network of claim 1, wherein the one or more service or maintenance documents comprise one or more of a user manual, a service or maintenance manual, or a manufacturer's instruction.

3. The data communications network of claim 1, wherein the one or more artificial intelligence techniques used to establish or modify a service or maintenance schedule for the apparatus comprises a predictive analytics algorithm that, in addition to analysing response(s) received from the user and guidance regarding service or maintenance of the apparatus, analyses additional inputs comprising one or more of:
data received from hardware associated with the apparatus,
historical servicing and/or maintenance data,
meteorological data,
apparatus usage statistics comprising usage trends,
user preferences,
user feedback, or
user habits with respect to use of the apparatus.

4. The data communications network of claim 3, wherein the hardware associated with the apparatus comprises one or more sensors or internet of things (IoT) devices, the method further comprising:
detecting, based on data received from the sensor(s) and/or IoT devices, abnormalities in the operation of the apparatus; and
generating an alert regarding the detected abnormality and the need for attention to reduce the prospects of failure or damage to the apparatus.

5. The data communications network of claim 3, wherein the one or more artificial intelligence techniques used to establish or modify the service or maintenance schedule comprises Google DeepMind.

6. The data communications network of claim 1, wherein interactions with the data communications device of the user, comprising initiating one or more relevant queries to the user, receiving responses thereto, and providing one or more service or maintenance notifications to the data communications device, are facilitated by the use of a conversational interface implemented using one or more artificial intelligence techniques.

7. The data communications network of claim 6, wherein the one or more artificial intelligence techniques used to provide the conversational interface comprises ChatGPT.

8. The data communications network of claim 1, wherein the method further comprises:
upon retrieving a copy of the document(s) relevant to the apparatus, providing a copy of the document(s) to the user.

9. The data communications network of claim 1, wherein the available resources comprise the internet operably connected to which is one or more external databases.

10. The data communications network of claim 1, wherein the identification details regarding the apparatus comprise any one or more of:
a product type,
a brand name,
a model number,
a product or serial number,
a part number,
a date of manufacture, or
service/maintenance agent details.

11. A data communications network of claim 1, wherein the method further comprises:
based upon issuance of the service or maintenance notification to the data communications device associated with the user, prompting the user to establish a work order for issuance to an entity that provides goods and/or services capable of addressing the service or maintenance requirement of the apparatus, or
based upon issuance of the service or maintenance notification to the data communications device associated with the user, automatically generating a work order to be issued to an entity that provides goods and/or services capable of addressing the service or maintenance requirement of the apparatus.

12. The data communications network of claim 11, wherein the method further comprises:
automatically, or based upon an instruction received from the user, dispatching the work order to an entity capably of fulfilling the work order that is either selected by the user or automatically selected.

13. The data communications network of claim 12, wherein an entity capable of fulfilling the work order is selected based on one or more of:
the location of the user,
the location of the entity,
credentials of the entity comprising qualifications, or
a track record of the entity.

14. The data communications network of claim 12, wherein the method further comprises:
receiving a response to the issued request from an entity of the one or more entities, wherein the response comprises acceptance or rejection of the request and in the event of acceptance, additional details comprising:
a proposed commencement date and time for the service or maintenance task,
an estimated completion date and time for the service or maintenance task, and
an estimate of fees for completing the maintenance task.

15. The data communications network of claim 1, wherein the method further comprises:
based upon the entity accepting the work order and the user accepting the proposed commencement date and time, the estimated completion date and time, and the estimate of fees, issuing the work order to the entity;
based on the work order being issued to the entity, tracking the progress of the work order.

16. The data communications network of claim 15, wherein tracking the progress of the work order comprises one or more of:
receiving task completion updates from the user and/or the entity completing the service or maintenance task; and
receiving data from one or more sensors associated with the apparatus on which the service or maintenance task is being performed.

17. The data communications network of claim 15, wherein the method further comprises:
providing the user and the entity assigned to complete service or maintenance tasks with the ability to upload information comprising notes recorded during the servicing or maintenance of the apparatus, the notes comprising one or more of written text, images, video and voice recordings, thereby establishing a historical record regarding servicing or maintenance of the apparatus.

18. The data communications network of claim 17, wherein the method further comprises:
providing a reporting feature enabling the user to generate and retrieve a report regarding the apparatus comprising the servicing or maintenance history for the apparatus comprising any notes recorded during past servicing and/or maintenance events.

19. A computer-implemented method for enabling a user to service or maintain an apparatus, the method comprising:
receiving, by one or more processors, identification details regarding the apparatus and upon receipt of same, performing, using one or more artificial intelligence techniques, a search of available resources to identify one or more items matching the apparatus;
providing, by one or more processors, for display on a data communications device associated with the user, a listing of all available matching items identified by the one or more processors;
receiving, by one or more processors, a selection from the user from the listing regarding the one or more items that match the apparatus for which the user seeks servicing or maintenance assistance;
based on the received selection, retrieving, by one or more processors, a copy of one or more service or maintenance documents relating to the apparatus and identifying, using one or more natural language processing techniques, guidance within the document(s) regarding servicing or maintenance of the apparatus;
initiating, by one or more processors, one or more relevant queries directed to the user regarding the previous use, service and/or maintenance of the apparatus to determine, using one or more natural language processing techniques applied to the responses(s) received from the user, a current servicing or maintenance status of the apparatus;
based upon the response(s) received from the user in response to the one or more queries initiated by the one or more processors, and said guidance regarding service or maintenance of the apparatus, establishing, by one or more processors, a servicing or maintenance schedule or a modification to an existing servicing or maintenance schedule for the apparatus; and
providing, by one or more processors, one or more service or maintenance notifications to the data communications device associated with the user regarding service or maintenance requirements applicable to the apparatus according to the established or modified schedule.

20. A non-transitory computer-readable medium comprising computer instruction code stored thereon, that when executed on a computer, causes one or more processors of the computer to perform the steps of:
receiving identification details regarding the apparatus and upon receipt of same, performing, using one or more artificial intelligence techniques, a search of available resources to identify one or more items matching the apparatus;
providing, for display on a data communications device associated with the user, a listing of all available matching items identified by the one or more processors;
receiving a selection from the user from the listing regarding the one or more items that match the apparatus for which the user seeks servicing or maintenance assistance;
based on the received selection, retrieving a copy of one or more service or maintenance documents relating to the apparatus and identifying, using one or more natural language processing techniques, guidance within the document(s) regarding servicing or maintenance of the apparatus;
initiating one or more relevant queries directed to the user regarding the previous use, service and/or maintenance of the apparatus to determine, using one or more natural language processing techniques applied to the responses(s) received from the user, a current servicing or maintenance status of the apparatus;
based upon the response(s) received from the user in response to the one or more queries initiated by the one or more processors, and said guidance regarding service or maintenance of the apparatus, establishing a servicing or maintenance schedule or a modification to an existing servicing or maintenance schedule for the apparatus; and
providing one or more service or maintenance notifications to the data communications device associated with the user regarding service or maintenance requirements applicable to the apparatus according to the established or modified schedule.
